(19) United States
(12) Patent Application Publication
(10) Pub. No.: US 2022/0153124 A1
(43) Pub. Date: May 19, 2022

(54) Hybrid Transmission for a Motor Vehicle Powertrain, Motor Vehicle Powertrain, and Motor Vehicle Comprising Same

(71) Applicant: ZF Friedrichshafen AG, Friedrichshafen (DE)

(72) Inventors: Stefan Beck, Eriskirch (DE); Matthias Horn, Tettnang (DE); Fabian Kutter, Kressbronn (DE); Michael Wechs, Weißensberg (DE); Johannes Kaltenbach, Friedrichshafen (DE); Thomas Martin, Weissensberg (DE); Thomas Kroh, Lindau (DE); Martin Brehmer, Tettnang (DE); Peter Ziemer, Tettnang (DE); Oliver Bayer, Hörbranz (AT); Max Bachmann, Friedrichshafen (DE)

(21) Appl. No.: 17/436,242

(22) PCT Filed: Oct. 15, 2019
(86) PCT No.: PCT/EP2019/077888

§ 371 Date: Sep. 3, 2021

(30) Foreign Application Priority Data
Mar. 5, 2019 (DE) 10 2019 202 965.5

(51) Int. Cl. B60K 6/547; F16H 3/091; B60K 6/36; B60K 6/387; B60K 6/44

(52) U.S. Cl. CPC B60K 6/547; F16H 3/091; B60K 6/36; F16H 2200/0078; B60K 6/44; B60Y 2200/92; F16H 2200/0047; B60K 6/387

(57) ABSTRACT

A hybrid transmission of a countershaft design for a motor vehicle powertrain having an internal combustion engine, a first electric prime mover, and a second electric prime mover has a transmission drive shaft drivingly connected to the second electric prime mover, a first sub-transmission having a first transmission input shaft, and a second sub-transmission having a second transmission input shaft, the second transmission input shaft being drivingly connected to the first electric prime mover. The transmission further has a first coupling element, the transmission drive shaft being connectable to the internal combustion engine via the first coupling element. Moreover, the transmission has a second coupling element, the first transmission input shaft being connectable to the second transmission input shaft via the second coupling element. Additionally, the transmission has a third coupling element, the transmission drive shaft being connectable to the first transmission input shaft via the third coupling element.

### CROSS-REFERENCE TO RELATED APPLICATION

The present application is related and has right of priority to German Patent Application No. 10 2019 202 965.5 filed on Mar. 5, 2019 and is a nationalization of PCT/EP2019/077888 filed in the European Patent Office on Oct. 15, 2019, both of which are incorporated by reference in their entirety for all purposes.

### FIELD OF THE INVENTION

The present invention relates to a hybrid transmission for a motor vehicle powertrain, a motor vehicle powertrain with a hybrid transmission of this type, and to a motor vehicle with a motor vehicle powertrain of this type.

### BACKGROUND

Vehicles are increasingly equipped with hybrid drives, i.e., with at least two different drive sources. Hybrid drives contribute to the reduction of fuel consumption and pollutant emissions. Drive trains having an internal combustion engine and one or multiple electric motors have largely prevailed as a parallel hybrid or as a mixed hybrid. These types of hybrid drives have an essentially parallel arrangement of the internal combustion engine and of the electric motor in the power flow. As a result, a superposition of the drive torques as well as a control with a purely internal combustion engine-generated drive or a purely electric motor-generated drive is made possible. Since the drive torques of the electric drive and of the internal combustion engine are combined, depending on the control, a comparatively smaller configuration of the internal combustion engine and/or its intermittent shut-down are/is possible, as the result of which a significant reduction of the CO₂ emissions is achieved without significant losses of power and comfort. The possibilities and advantages of an electric drive are thereby combined with the range, power, and cost advantages of internal combustion engines.

One disadvantage of the aforementioned hybrid drives consists of a generally more complex configuration since both drive sources preferably transmit input power to an input shaft with only one transmission. Moreover, individual gear steps are utilized at times by only one drive source. A reduction of the complexity of the configuration of a hybrid transmission is usually associated with a loss of variability.

Publication DE 10 2011 005 451 A1 describes a hybrid drive of a motor vehicle, which includes an automated transmission having two input shafts and a shared output shaft. The first input shaft is connectable to the drive shaft of an internal combustion engine via a separating clutch and is able to be brought into a drive connection with the output shaft via a first group of selectively engageable gear-step gear sets. The second input shaft is drivingly connected to the rotor of an electric machine, which is operable as a motor and as a generator, and is able to be brought into a drive connection with the output shaft via a second group of selectively engageable gear-step gear sets. The input shafts are coupleable to each other via an engageable and disengageable coupling shift element. In order to improve the operating properties of the hybrid drive, a second electric machine operable as a motor and as a generator is provided, the rotor of which is drivingly connected to the first input shaft.

The disadvantage in this connection is that only a portion of the gear steps is associated with the electric prime mover, in particular during a serial operation. Low gear steps for the electric prime mover are often advantageous, since electric machines are operated at high rotational speeds. The potential of the electric prime mover is optimally exploited in low gear steps. However, a portion of the low gear steps of the electric prime mover is available only for the case in which the internal combustion engine is entrained into motion. A serial operation with all gear steps has previously not been implementable.

### SUMMARY OF THE INVENTION

Against this background, the problem addressed by the present invention is that of providing a hybrid transmission and a drive train having a better combinability of the internal-combustion-engine and electric-motor gear steps. In particular, a hybrid transmission and a drive train are provided, which, due to their properties with regard to small installation space, high variability, and efficient manufacturability, are suitable for a serial production in the automotive industry. Preferably, low gear steps, which are associated with the electric prime mover, are to have a small ratio step.

In order to solve this problem, the invention relates to a hybrid transmission of a countershaft design for a motor vehicle drive train or powertrain having an internal combustion engine, a first electric prime mover, and a second electric prime mover, having a transmission drive shaft, which is drivingly connected to the second electric prime mover, a first sub-transmission having a first transmission input shaft, a second sub-transmission having a second transmission input shaft, which is drivingly connected to the first electric prime mover, a first coupling element for the detachable operative connection of the transmission drive shaft to the internal combustion engine, a second coupling element for the detachable operative connection of the first transmission input shaft and the second transmission input shaft, and a third coupling element for the detachable operative connection of the transmission drive shaft to the first transmission input shaft.

The above-described problem is solved, furthermore, by a motor vehicle drive train having an internal combustion engine for providing input power, a first electric prime mover for providing input power, a second electric prime mover for providing input power, and an above-described hybrid transmission.

The above-described problem is solved, furthermore, by a motor vehicle having an above-described motor vehicle drive train, an energy accumulator for storing energy for supplying the first electric prime mover, the second electric prime mover, and a vehicle electronics system, and a main power circuit for transmitting the energy between the energy accumulator and the first electric prime mover and/or the second electric prime mover.

Preferred embodiments of the invention are described in the dependent claims. It is understood that the features, which are mentioned above and which will be described in greater detail in the following, are usable not only in the particular combination indicated, but also in other combinations or alone, without departing from the scope of the present invention. In particular, the motor vehicle drive train and the motor vehicle is designed according to the embodiments of the hybrid transmission described in the dependent claims.

The arrangement of the first, second, and third coupling elements allows for a high variability of the hybrid transmission. The first electric prime mover, which is preferably utilized as a main prime mover, utilizes all gear steps of the first sub-transmission and the second sub-transmission. In particular, a serial operation is established, in which the internal combustion engine drives the second electric prime mover, in order to supply the first electric prime mover with energy. In special cases, such as in the presence of high driving resistance, the first electric prime mover utilizes the first gear, i.e., the lowest gear stage, in the first sub-transmission. Moreover, the second electric prime mover assists the internal combustion engine during a synchronization for gear changes in a hybrid operation. The preferred design is an arrangement in the front-mounted transverse design or the rear-mounted transverse design, i.e., having a lateral drive output.

In one preferred embodiment, the hybrid transmission includes multiple shift elements for engaging a total of five gear steps, and gearwheel pairs of idler gears and fixed gears, which are arranged in multiple gear set planes, for forming the gear steps. One gearwheel pair of a gear step is arranged at another sub-transmission from the gearwheel pairs of adjacent gear steps. As a result, a tractive force loss-free shift is achieved. A gear change is comfortably carried out. The motor vehicle accelerates faster and the hybrid transmission shifts more efficiently.

In one preferred embodiment, the first sub-transmission is drivingly connected to the first electric prime mover at a fixed gear of the gear pair that forms the highest gear step on the first sub-transmission. In this way, a high reduction ratio for the first electric prime mover is preferably be achieved without a further gear stage. The transmission is more lightweight and less complicated, since fewer components must be utilized. The first electric prime mover is operated in a highly efficient speed range.

In one preferred embodiment, an idler gear of the first gear step and/or of the second gear step includes, together with a further gear-forming gearwheel pair, a shared shift element. Additionally, or alternatively, the shift elements are form-locking shift elements. Additionally, or alternatively, furthermore, at least two shift elements are double shift elements, which are actuatable by a double-acting actuator. Due to the provision of double shift elements, the control during gear changes is simplified. In addition, the number of actuators needed for the open-loop control of the hybrid transmission is kept low. The hybrid transmission is cost-efficient and less susceptible to error.

In one preferred embodiment, the coupling elements are friction-locking or form-locking coupling elements. At least one coupling element forms, together with one shift element, a double element, which is actuatable by a double-acting actuator. Due to the provision of friction-locking coupling elements, the synchronization of the transmission during gear changes is simplified. Due to the provision of form-locking coupling elements, the hybrid transmission is cost-efficiently represented. In addition, the power transmission in the transmission is more efficient. Due to a double element, the number of actuators needed for the open-loop control of the hybrid transmission is kept low.

In one preferred embodiment, the first transmission input shaft and the second transmission input shaft are arranged coaxially to one another. One of the transmission input shafts is a hollow shaft and encompasses the other transmission input shaft, at least in sections. As a result, the transmission is compact. Moreover, due to the advantageous arrangement of the transmission input shafts, a shared countershaft is utilized, which simplifies the assembly of the hybrid transmission.

In one preferred embodiment, the first transmission input shaft and the second transmission drive shaft are arranged coaxially to one another. In this way, the connection of the transmission drive shaft to the first transmission input shaft and to the second transmission input shaft is simplified. The transmission is compact and has few components.

In one preferred embodiment of the motor vehicle drive train, the second electric prime mover is actuatable as an integrated starter generator for starting the internal combustion engine. Additionally or alternatively, the second electric prime mover is actuatable as a charging generator for charging an energy accumulator, for supplying a main power circuit, and/or for supplying the first electric prime mover during a serial operation. In this way, the hybrid transmission is efficiently operated. For example, a so-called stationary charging is possible. The fuel consumption is reduced. Moreover, an additional starter for the internal combustion engine is omitted.

In one preferred embodiment, the first electric prime mover and/or the second electric prime mover are/is arranged axially parallel to the first transmission input shaft and/or the second transmission input shaft. A connection of the electric machines to the hybrid transmission is technically easily possible in this case. Moreover, due to the advantageous arrangement, the available installation space is utilized, in order to use correspondingly large electric machines. The motor vehicle drive train is compact and powerful.

In one preferred embodiment, the second electric prime mover and/or the internal combustion engine are/is actuatable, at least partially, as a supporting force means during gear changes of the first electric prime mover. Additionally or alternatively, the first electric prime mover is actuatable, at least partially, as a supporting force means during gear changes of the second electric prime mover and/or of the internal combustion engine. As a result, a comfortable changeover of the gear stages is made possible. Moreover, the hybrid transmission has lower wear and a higher stability against failure.

A gear step changeover takes place by disengaging one shift element and simultaneously engaging the shift element for the next-higher or -lower gear step. The second shift element therefore gradually takes on the torque from the first shift element, until, by the end of the gear step changeover, the entire torque has been taken on by the second shift element. If synchronization is carried out in advance, a gear change takes place faster.

Entraining the internal combustion engine into motion is understood to mean starting the internal combustion engine or setting the internal combustion engine into rotation. The entrainment into motion takes place by at least partially engaging a friction clutch with a gear step engaged and the ignition switched on, wherein the ‘momentum’ of a vehicle in motion, i.e., the kinetic energy, is transmitted by the power train to the internal combustion engine.

In the present case, an internal combustion engine is any machine that generates a turning motion by burning a fuel, such as gasoline fuel, diesel fuel, kerosene, ethanol, liquefied gas, liquefied petroleum gas, etc. An internal combustion engine is, for example, a spark-ignition engine, a diesel engine, a Wankel rotary piston engine®, or a two-stroke engine.

An actuator in the present case is a component that converts an electrical signal into a mechanical motion. Preferably, actuators that are utilized with double shift elements carry out movements in two opposite directions, in order to engage one shift element of the double shift element in the first direction and to engage the other shift element in the second direction.

A coupling element is understood, in the present case, to be a component that detachably operatively connects a prime mover, such as an internal combustion engine, an electric prime mover, or a transmission shaft to a further transmission input shaft. A coupling element is, for example, a dog clutch, a friction clutch, a hydraulic clutch/fluid clutch, or a synchronizer sleeve. The connection takes place, for example, via a frictional connection or a positive engagement.

A ratio step is understood to be the difference in the ratio of two, preferably adjacent, gear steps. A low ratio step means that the ratio of the gear steps differs only a little. Ratio steps between adjacent gear steps are therefore smaller than ratio steps, in which one gear step is left out.

A serial driving operation is to be understood to be an operating mode, in which the internal combustion engine acts as a drive for an electric prime mover operated as a generator, which supplies a second electric prime mover, and so the internal combustion engine is decoupled from the driving wheels and, preferably, is operated continuously at a single, low-emission operating point.

Stationary charging is understood to be the operation of the electric prime mover as a generator, preferably while the vehicle is at rest with the internal combustion engine running, in order to charge an energy accumulator and/or to supply onboard electronics.

### BRIEF DESCRIPTION OF THE DRAWINGS

The invention is described and explained in greater detail in the following with reference to a few selected exemplary embodiments in conjunction with the attached drawings, in which:

FIG. 1 shows a schematic view of a motor vehicle drive train according to the invention;

FIG. 2 shows a schematic view of a motor vehicle with a motor vehicle drive train according to the invention;

FIG. 3 shows a schematic view of a hybrid transmission according to the invention in a motor vehicle drive train;

FIG. 4 shows a schematic view of a gear shift matrix of the hybrid transmission according to the invention from FIG. 3; and

FIG. 5 shows a schematic view of an embodiment of a hybrid transmission according to the invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

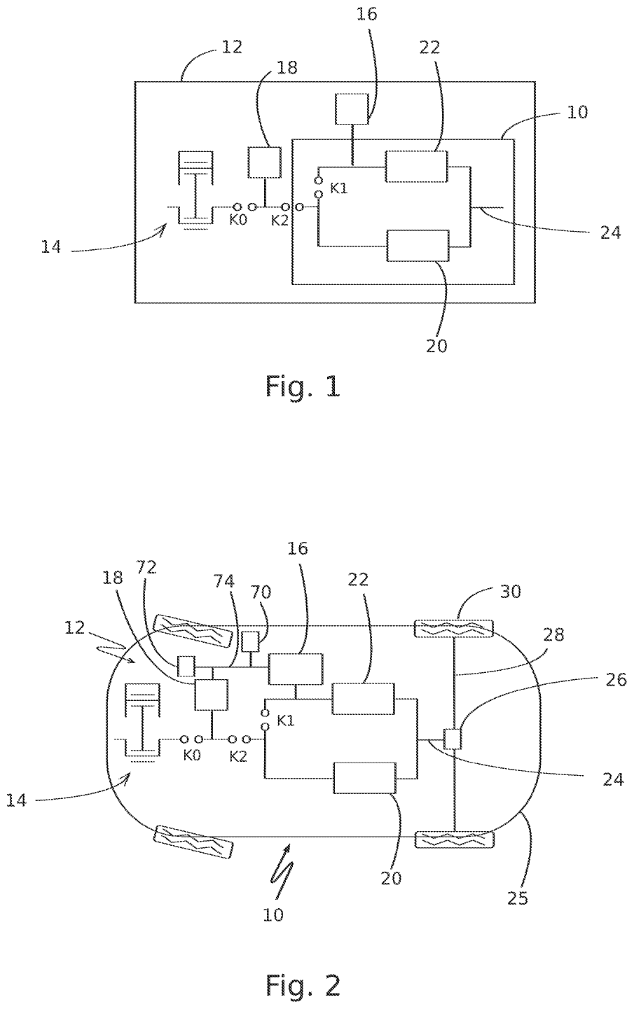

FIG. 1 diagrammatically shows an embodiment of a hybrid transmission 10 in a motor vehicle drive train 12. The motor vehicle drive train 12 includes an internal combustion engine 14, a first electric prime mover 16, and a second electric prime mover 18. The hybrid transmission 10 includes a first sub-transmission 20, a second sub-transmission 22, and a drive output arranged at a countershaft 24. The first electric prime mover 16 is operatively connected to the second sub-transmission 22. The internal combustion engine 14 is operatively connected to the second electric prime mover 18 by a first coupling element K0. By a second coupling element K1, the first sub-transmission 20 is operatively connected to the second sub-transmission 22. By a third coupling element K2, the second electric machine 18 is operatively connected to the first sub-transmission 20. Therefore, if the first and third coupling elements K0 and K2 are engaged, the internal combustion engine 14 is also operatively connected to the first sub-transmission 20. Moreover, by additionally engaging the second coupling element K1, the second sub-transmission 22 is utilized for the internal combustion engine 14 and/or the second electric prime mover 18.

With this arrangement of the coupling elements K0, K1, K2, each gear step, regardless of which sub-transmission it is located on, is engaged for each of the prime movers 14, 16, 18. In particular, the first electric prime mover 16 utilizes the first gear, i.e., the lowest gear stage, of the first sub-transmission 20. It is possible to implement a serial operation. For this purpose, the third coupling element K2 is disengaged and the first coupling element K0 is engaged. The internal combustion engine 14 then drives the second electric prime mover 18 as a generator and, in this way, provides energy, which is delivered to the first electric prime mover 16.

In a hybrid operation, i.e., when the internal combustion engine 14 and at least one of the electric prime movers 16, 18 are utilized for driving a motor vehicle, the second electric prime mover 18 assists the internal combustion engine 14 during a synchronization, for example, in order to shift the individual gear steps. In this example, the first electric prime mover 16 is a main prime mover and preferably utilizes the second gear, which is located in the second sub-transmission 22. In particular driving situations such as, for example, in the presence of high driving resistance, the first electric prime mover 16 also utilizes the first gear, which is arranged in the first sub-transmission 20. For this purpose, the two sub-transmissions must be connected by the second coupling element K1.

FIG. 2 diagrammatically shows a motor vehicle 25 with an above-described motor vehicle drive train 12 and an above-described hybrid transmission 10. The drive output arranged at the countershaft 24 transmits the input power to a differential 26. The differential 26 distributes the input power via an output shaft 28 to the driven wheels 30 of the motor vehicle 25. In this example, only one axle of the motor vehicle 25 is driven. It is understood that an all-wheel drive is also implemented, in that, for example, the drive output arranged at the countershaft 24 drives a further differential, in order to drive a further input shaft and, thereby, further wheels 30. The motor vehicle 25 includes, furthermore, an energy accumulator 70 for supplying the first electric prime mover 16, the second electric prime mover 18, and a vehicle electronics system 72. The energy accumulator 70 is, for example, in the form of a battery or a capacitor. A main power circuit 74 is provided for transmitting the energy between the energy accumulator 70 and the first electric prime mover 16 and/or the second electric prime mover 18.

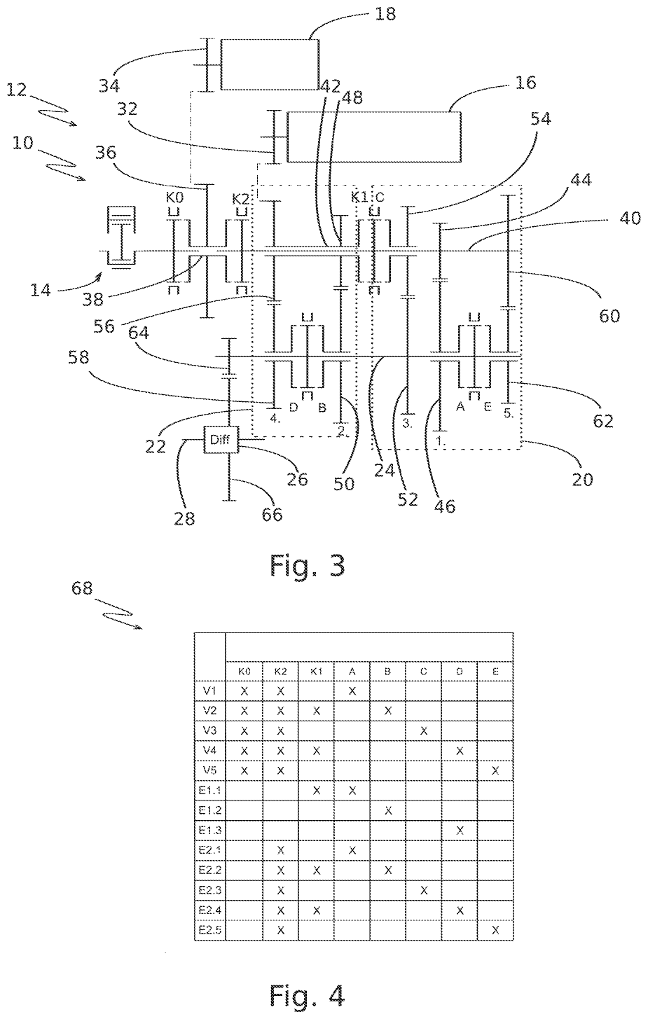

FIG. 3 diagrammatically shows an embodiment of a hybrid transmission 10 in a motor vehicle drive train 12. Identical reference characters refer to identical features. The first electric prime mover 16 includes a fixed gear 32 at an output shaft and is connected to the second sub-transmission 22 by the fixed gear 32. The second electric prime mover 18 includes a fixed gear 34 at an output shaft. The fixed gear 34 is in engagement with a fixed input gear 36, which is located at a transmission drive shaft 38. The transmission drive shaft 38 is operatively connected to a first transmission input shaft 40 of the first sub-transmission 20 by the third coupling element K2.

The first transmission input shaft 40 of the first sub-transmission 20 is operatively connected to a second transmission input shaft 42 of the second sub-transmission 22 by the second coupling element K1. The first transmission input shaft 40 is a solid shaft. The second transmission input shaft 42 is a hollow shaft and encompasses the first transmission input shaft 40, at least in sections.

The first sub-transmission 20 includes a first gear step 1, a third gear step 3, and a fifth gear step 5. The first gear step 1 is formed by a gearwheel pair, which includes a fixed gear 44 at the first transmission input shaft 40 and an idler gear 46 at the countershaft 24. The idler gear 46 is operatively connected or “connectable” to the countershaft 24 by a first shift element A.

The second sub-transmission 22 includes a second gear step 2 and a fourth gear step 4. The second gear step 2 is formed by a fixed gear 48 at the second transmission input shaft 42 and an idler gear 50 at the countershaft 24. The idler gear 50 is operatively connected or “connectable” to the countershaft 24 by a second shift element B.

The third gear step 3 is formed by a fixed gear 52 at the countershaft 24 and an idler gear 54 at the first transmission input shaft 40. The idler gear 54 is operatively connected or “connectable” to the first transmission input shaft 40 by a third shift element C.

The fourth gear step 4 is formed by a fixed gear 56 at the second transmission input shaft 42 and an idler gear 58 at the countershaft 24. The idler gear 58 is operatively connected or “connectable” to the countershaft 24 by a fourth shift element D.

The fifth gear step 5 is formed by a fixed gear 60 at the first transmission input shaft 40 and an idler gear 62 at the countershaft 24. The idler gear 62 is operatively connected or “connectable” to the countershaft 24 by a fifth shift element E.

The countershaft 24 includes, furthermore, a drive output, which includes a first output gearwheel 64 and a second output gearwheel 66 in engagement with the first output gearwheel 64. The second output gearwheel 66 is operatively connected or “connectable” to the differential 26, wherein the differential 26 distributes the input power via the output shaft 28.

The second electric prime mover 18 is coupled to the internal combustion engine 14 by the first coupling element K0 and to the first transmission input shaft 40 by the third coupling element K2. In the axially parallel arrangement shown here, the second electric prime mover 18 is connected to the transmission drive shaft 38 either by one or multiple spur gear(s), or by a traction mechanism such as, for example, a chain or a belt.

In particular driving situations such as, for example, in the presence of high driving resistance, the first electric prime mover 16 utilized as a main prime mover uses the shortest or lowest gear to drive the motor vehicle. The first shift element A, the first coupling element K0, and the second coupling element K1 are engaged. The first electric prime mover 16 therefore utilizes the first gear and, thereby, the lowest ratio. In this case, the motor vehicle is in a serial operation. The second electric prime mover 18 operates as a generator and is operatively connected to the internal combustion engine 14 by the engaged first coupling element K0. In this case, the third coupling element K2 is disengaged, in order to decouple the second electric prime mover 18 from the hybrid transmission 10, allowing the second electric prime mover 18 to be effectively operated as a generator.

A transition out of the above-described serial operation into a hybrid operation is possible. For this purpose, the third coupling element K2 is engaged. Thereafter, the internal combustion engine 14, together with the second electric prime mover 18, supports the tractive force, allowing the second coupling element K1 to be disengaged. In this case, the first electric prime mover 16 is load-free and synchronizes the second shift element B. The second shift element B is engaged, and so the second gear, i.e., the second-lowest gear stage, is engaged for the first electric prime mover 16.

Thereafter, the first electric prime mover 16 supports the tractive force and the internal combustion engine 14, together with the second electric prime mover 18, switches into a no-load condition. For example, a shift into the second gear step takes place by disengaging the first shift element A and engaging the second coupling element K1. The third coupling element K2 preferably remains engaged during this process.

FIG. 4 shows a gear shift matrix 68 of the hybrid transmission 10 from FIG. 3 and the following embodiment of a hybrid transmission 10. A total of 13 shift conditions are represented. In the first column, internal-combustion-engine gear steps V1, V2, V3, V4, V5 of the internal combustion engine 14 as well as electric-machine gear steps E1.1, E1.2, E1.3 of the first electric prime mover 16 and electric-machine gear steps E2.1, E2.2, E2.3, E2.4, E2.5 of the second electric prime mover 18 are represented. The shift conditions of the coupling elements K0, K2, K1 are represented in the second through fourth columns. The shift conditions of the shift elements A, B, C, D, E are represented in the fifth through ninth columns. An “X” for a coupling element means that it is engaged, i.e., drivingly connects the two shafts to each other that are associated with the coupling element. An “X” for a shift element means that it is engaged, i.e., drivingly connects the idler gear associated therewith to the shaft associated therewith. Consequently, the gear stages 1, 2, 3, 4, 5 of the hybrid transmission 10 which correspond to the internal-combustion-engine gear steps V1, V2, V3, V4, V5, the electric-machine gear steps E1.1, E1.2, E1.3, E2.1, E2.2, E2.3, E2.4, E2.5 is apparent from the gear shift matrix 68.

In order to engage the internal-combustion-engine gear steps V1, V2, V3, V4, V5, therefore, the first and third coupling elements K0, K2 must always be engaged so that the internal combustion engine 14 is connected to the hybrid transmission 10. In order to engage a first internal-combustion-engine gear step V1, the first shift element A is also engaged. In order to engage a second internal-combustion-engine gear step V2, the first sub-transmission 20 and the second sub-transmission 22 must be drivingly connected to each other, i.e., the second coupling element K1 must also be engaged and the second shift element B is also engaged. In order to engage a third internal-combustion-engine gear step V3, the third shift element C is also engaged. In order to engage a fourth internal-combustion-engine gear step V4, the second coupling element K1 and the fourth shift element D are also engaged. The fifth shift element E is additionally engaged for the fifth internal-combustion-engine gear step V5. Provided that the coupling elements and/or shift elements are not designated as engaged, it is to be assumed that they are in the disengaged condition.

The first and third coupling elements K0, K2 are disengaged for the electric-machine gear steps E1.1, E1.2, E1.3 of the first electric prime mover 16. The second coupling element K1 and the first shift element A are engaged for a first electric-machine gear step E1.1 of the first electric prime mover 16. The second shift element B is engaged for a second electric-machine gear step E1.2 of the first electric prime mover 16. The fourth shift element D is engaged for a third electric-machine gear step E1.3 of the first electric prime mover 16.

The third coupling element K2 is engaged for the electric-machine gear steps E2.1, E2.2, E2.3, E2.4, E2.5 of the second electric prime mover 18. The first shift element A is to be additionally engaged for a first electric-machine gear step E2.1 of the second electric prime mover 18. The second coupling element K1 and the second shift element B are to be engaged for a second electric-machine gear step E2.2 of the second electric prime mover 18. The third shift element C is to be engaged for a third electric-machine gear step E2.3 of the second electric prime mover 18. The fourth shift element D and the second coupling element K1 are to be engaged for a fourth electric-machine gear step E2.4 of the second electric prime mover 18. The fifth shift element E is to be engaged for a fifth electric-machine gear step E2.5 of the second electric prime mover 18.

In a hybrid operation, the internal-combustion-engine gear steps V1, V2, V3, V4, V5 are combined with the electric gear steps E1.1, E1.2, E1.3. Moreover, it is also conceivable to also utilize the electric gear steps E2.1, E2.2, E2.3, E2.4, E2.5, which are engaged similarly to the combustion gear steps V1, V2, V3, V4, in a hybrid mode.

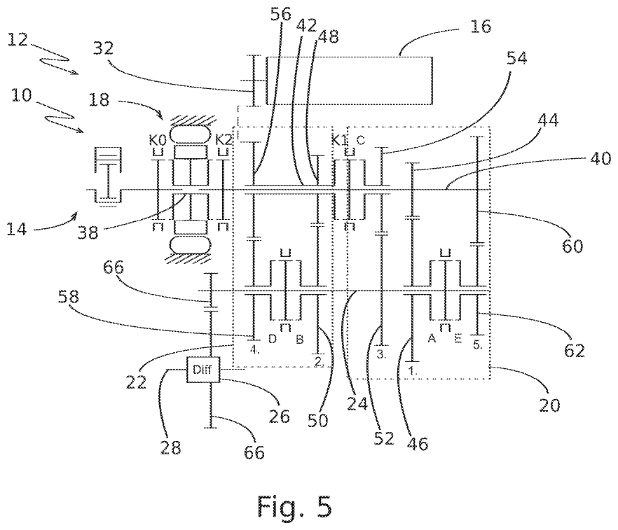

A further variant of a hybrid transmission 10 is diagrammatically shown in FIG. 5. Identical reference characters refer to identical features. The differences are to be discussed in the present case. The second electric prime mover 18 is a coaxial machine in this case, wherein a stator of the second electric prime mover 18 is rotationally fixed to a transmission housing or the like. A rotor of the second electric prime mover 18 forms the transmission drive shaft 38. It is understood that a reduction gear, for example, in the form of a planetary gear set, is provided in order to step up or step down the input power between the rotor and the transmission drive shaft 38.

Furthermore, it is understood that the arrangement of the fixed gears and the idler gears, including the shift elements, is interchanged in the embodiments shown. It is provided, for example, that no shift elements and no idler gears are provided at the countershaft 24. Moreover, the order of the individual gear steps is interchangeable, wherein, preferably, a high gear step is arranged at an end or a beginning of a transmission in order to connect an electric prime mover by a fixed gear having a high gear step to a sub-transmission and, thereby, have axial installation space available in order to be able to utilize an axially long electric prime mover.

It is understood, furthermore, that the first electric prime mover can also be a coaxial machine, wherein the rotor is part of the second transmission input shaft 42. It is also conceivable that a reduction gear, for example, in the form of a planetary gear set, is provided between the rotor of the coaxial machine and the second transmission input shaft 42.

The invention was comprehensively described and explained with reference to the drawings and the description. The description and the explanation are to be understood as an example and are not to be understood as limiting. The invention is not limited to the disclosed embodiments. Other embodiments or variations result for a person skilled in the art within the scope of the utilization of the present invention and within the scope of a precise analysis of the drawings, the disclosure, and the following claims.

In the claims, the words “comprise” and “comprising” do not rule out the presence of further elements or steps. The indefinite article “a” does not rule out the presence of a plurality. A single element or a single unit carries out the functions of several of the units mentioned in the claims. The mere mention of a few measures in multiple various dependent claims is not to be understood to mean that a combination of these measures cannot also be advantageously utilized.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 hybrid transmission
12 motor vehicle drive train
14 internal combustion engine
16 first electric prime mover
18 second electric prime mover
20 first sub-transmission
22 second sub-transmission
24 countershaft
25 motor vehicle
26 differential
28 output shaft
30 wheel
32 fixed gear of the first electric prime mover
34 fixed gear of the second electric prime mover
36 fixed input gear
38 transmission drive shaft
40 first transmission input shaft
42 second transmission input shaft
44 fixed gear of the first gear step
46 idler gear of the first gear step
48 fixed gear of the second gear step
50 idler gear of the second gear step
52 fixed gear of the third gear step
54 idler gear of the third gear step
56 fixed gear of the fourth gear step
58 idler gear of the fourth gear step
60 fixed gear of the fifth gear step
62 idler gear of the fifth gear step
64 first output gearwheel
66 second output gearwheel
68 gear shift matrix
70 energy accumulator
72 vehicle electronics system
74 main power circuit

1-12. (canceled)

13. A hybrid transmission (10) of a countershaft design for a motor vehicle powertrain (12) having an internal combustion engine (14), a first electric prime mover (16), and a second electric prime mover (18), the hybrid transmission (10) comprising:
a transmission drive shaft (38) drivingly connected to the second electric prime mover (18);
a first sub-transmission (20) having a first transmission input shaft (40);
a second sub-transmission (22) having a second transmission input shaft (42), the second transmission input shaft (42) being drivingly connected to the first electric prime mover (16);
a first coupling element (K0), the transmission drive shaft (38) being connectable to the internal combustion engine (14) via the first coupling element (K0);
a second coupling element (K1), the first transmission input shaft (40) being connectable to the second transmission input shaft (42) via the second coupling element (K1); and
a third coupling element (K2), the transmission drive shaft (38) being connectable to the first transmission input shaft (40) via the third coupling element (K2).

14. The hybrid transmission (10) of claim 13, further comprising:
multiple shift elements (A, B, C, D, E) for engaging a total of five gear steps (1, 2, 3, 4, 5); and
multiple gearwheel pairs for forming multiple gear steps, each of the gearwheel pairs including a respective idler gear and a respective fixed gear arranged in a respective gear set plane,
wherein one of the multiple gear steps is arranged at one of the first and second sub-transmissions and adjacent gear steps of the multiple gear steps to the one of the multiple gear steps are in another of the first and second sub-transmissions.

15. The hybrid transmission (10) of claim 14, wherein the first sub-transmission (20) is drivingly connected to the first electric prime mover (16) at the fixed gear of a gearwheel pair of the multiple gearwheel pairs that forms a highest gear step of the multiple gear steps in the first sub-transmission.

16. The hybrid transmission (10) of claim 14, wherein:
the idler gear of each of one or both of a first gear step and a second gear step of the multiple gear steps includes a shared shift element with a further gear-forming gearwheel pair of the multiple gearwheel pairs,
the multiple shift elements (A, B, C, D, E) are form-locking shift elements, and
at least two of the multiple shift elements are double shift elements, each of the double shift elements being actuatable by a respective double-acting actuator.

17. The hybrid transmission (10) of claim 14, wherein:
the first, second, and third coupling elements (K0, K1, K2) are friction-locking or form-locking coupling elements, and
at least one of the first, second, and third coupling elements forms a double element with one of the multiple shift elements, each double element being actuatable by a respective double-acting actuator.

18. The hybrid transmission (10) of claim 13, wherein:
the first transmission input shaft (40) and the second transmission input shaft (42) are coaxial, and
one of the first and second transmission input shafts is a hollow shaft and at least partially encompasses another of the first and second transmission input shafts.

19. The hybrid transmission (10) of claim 13, wherein the first transmission input shaft (40) and the second transmission input shaft (38) are coaxial.

20. A motor vehicle powertrain (12), comprising:
an internal combustion engine (14) for providing input power;
a first electric prime mover (16) for providing input power;
a second electric prime mover (18) for providing input power; and
the hybrid transmission (10) of claim 13.

21. The motor vehicle powertrain (12) of claim 20, wherein the second electric prime mover (18) is an integrated starter generator for starting the internal combustion engine (14), and
wherein the second electric prime mover (18) is operable as a charging generator for one or more of charging an energy accumulator, supplying a main power circuit, and supplying the first electric prime mover during a serial operation.

22. The motor vehicle powertrain (12) of claim 20, wherein one or both of the first electric prime mover (16) and the second electric prime mover (18) is arranged axially parallel to one or both of the first transmission input shaft (40) and the second transmission input shaft (42).

23. The motor vehicle powertrain (12) of claim 20, wherein:
one or both of the second electric prime mover (18) and the internal combustion engine (14) at least partially provides supporting force during gear changes of the first electric prime mover (16); and
the first electric prime mover (16) at least partially provides supporting force during gear changes of one or both of the second electric prime mover and the internal combustion engine.

24. A motor vehicle (25), comprising the motor vehicle powertrain (12) of claim 20, the motor vehicle (25) further comprising:
an energy accumulator (70) for storing energy for supplying the first electric prime mover (16), the second electric prime mover (18), and a vehicle electronics system (72); and
a main power circuit (74) for transmitting the energy between the energy accumulator and one or both of the first electric prime mover and the second electric prime mover.
